(19) United States
(12) Patent Application Publication
(10) Pub. No.: US 2013/0200012 A1
(43) Pub. Date: Aug. 8, 2013

(54) Fluid Treatment System with Self-Cleaning Filter

(71) Applicants: Timothy L. Holmes, Kingwood, TX (US); David J. Burns, Mineral Wells, TX (US)

(72) Inventors: Timothy L. Holmes, Kingwood, TX (US); David J. Burns, Mineral Wells, TX (US)

(73) Assignee: Perry Equipment Corporation, Mineral Wells, TX (US)

(21) Appl. No.: 13/365,815

(22) Filed: Feb. 3, 2012

(51) Int. Cl. B01D 36/02; B01D 29/64; B01D 21/02

(52) U.S. Cl. 210/804; 210/323.1

(57) ABSTRACT

There is disclosed a method and apparatus for treating fluid in a fluid treatment system with self-cleaning filters. The liquid treatment system includes a tank defining an interior volume of at least 25 gallons. The tank includes a gravity settling portion proximate a lower end of the tank and generally configured in a frustoconical shape. A self-cleaning filter device is coupled to a top portion of the tank. The self-cleaning filter device is configured to filter out solids from fluid entering the tank and return filtered solids to the tank. Solids in the fluid, entering the tank, are removed from the fluid both by the filter device and by gravity.

### FIELD OF THE INVENTION

This invention generally relates to fluid treatment, and more particularly to removal of solids in production water with a liquid treatment system having self-cleaning filter devices and a gravity settling configuration.

### BACKGROUND OF THE INVENTION

During oil and gas drilling, well completion, and production, waste water (also called production and flow-back water) is produced. Flow-back water is a waste water stream that flows out of the well after the hydraulic fracturing process is completed. Production water is a salty waste water stream that flows out of the well in conjunction with the oil and or natural gas that the well is producing. Flow-back and production water commonly contain propant sand (sand that is used to hold production reservoir fractures open for oil and gas flow, after the hydraulic fracturing pressure is released), completion chemical and oil mixtures that form semi-solid gels, hydrocarbons, and production reservoir formation solids. Normally, flow-back and production waste water is transported, by truck, from the well to a disposal site or recycling center. At disposal sites, trucks will off-load the water by pumping it through a filter, for example a bag filter, followed by a series of separate settling tanks. Once most of the solids and hydrocarbons are removed the waste water is filtered again and pumped into a deep disposal injection well. Waste water recycling centers use the same type of pre-treatment systems to filter and settle hydrocarbon liquids, solids, and semi-solids.

In a typical disposal operation, bag filtration is used for the filtering system. The bag filtration removes solid and semi-solid contaminants that are suspended in the water pumped from the trucks. The bag filtration system is typically located downstream from where the trucks offload and discharge their fluid cargo and upstream from a series of settling tanks. The operators must periodically remove the bag filters from canisters and replace them with new bag filters. Such bag filter handling and disposal increase the costs of treating water from gas and oil production sites.

Typically bag filters will fill up and require changing after filtering 100 to 200 barrels of water. Prior to disposal of used bags, operators will dump out collected solids and place the bags on a contaminant containment rack to allow gravity drainage of oil, hydrocarbon liquids and semisolids from the bag. The process is messy, hard to control from an environmental standpoint, and expensive.

The apparatus and method in the present disclosure eliminates the use of bag filters and the associated cost and mess related to such bag filter process. Further, the present disclosure removes solids from fluid in an efficient and cost effective manner. The apparatus of the present disclosure as constructed is both durable and long lasting, and requires little or no maintenance to be provided by the user throughout its operating life. In order to enhance the market appeal, the apparatus of the present disclosure should also be of inexpensive construction to thereby afford the broadest possible market. Finally, it is also an objective that all the aforesaid advantages and objectives to be achieved without incurring any substantial relative disadvantage.

### BRIEF SUMMARY OF THE INVENTION

In one aspect, the disclosure provides a liquid treatment system. The liquid treatment system includes a tank defining an interior volume of at least 25 gallons. The tank includes a gravity settling portion proximate a lower end of the tank and generally configured in a frustoconical shape. A self-cleaning filter devise is coupled to a top portion of the tank. The self-cleaning filter device is configured to filter out solids from fluid entering the tank and return filtered solids to the tank. Solids in the fluid entering the tank are removed from the fluid by both the filter device and by gravity.

In another aspect, the self-cleaning filter device includes a filter head and a filter assembly. The filter head includes an inlet port and an outlet port with each port configured to facilitate fluid movement into and out of the tank. The filter assembly is coupled to the filter head with the filter assembly including a filter media extending along an axis into the interior of the tank. A wiper is operatively configured to engage a surface of the filter media with the wiper removing solids trapped by the filter media as the filter media is rotated by a motor coupled to the filter head. The solids filtered from the fluid by the filter media are dislodged from the filter media into the tank with the filter assembly disposed in the tank between the inward port and the outlet port. In yet another embodiment, the liquid treatment system includes an additional self-cleaning filter device coupled to the top portion of the tank and exposed to the interior of the tank in parallel circuit with the other self-cleaning filter device.

In another aspect, the disclosure provides a method of treating fluid in a liquid treatment system. The fluid treatment system includes a tank defining an interior having a volume of at least 25 gallons, with the tank including a gravity settling portion proximate a lower end of the tank. The liquid treatment system includes a self-cleaning filter device coupled to the tank. The method includes transporting liquid to the tank and moving the liquid into the tank. The method removes a portion of solids from the liquid by gravitational settling into the gravity settling portion of the tank. Moving the liquid through the self-cleaning filter device wherein an additional portion of solids in the liquid is removed by the filter. Filtered liquid is then removed from the tank. In another aspect, the moving of the liquid into the tank is done intermittently with sufficient time between movements to allow for settling of the solids removed from the liquid by both the self-cleaning filter and the gravity settling process.

In yet another aspect, the disclosure provides a liquid treatment system including a tank that defines an interior having a volume of at least 25 gallons. The tank includes a gravity settling portion proximate a lower end of the tank. A self-cleaning filter device is coupled to a top portion of the tank and configured to filter out solids from the fluid entering the tank and return filtered solids to the tank. Solids in the fluid entering the tank are removed from the fluid by the filter device and by gravity. The self-cleaning filter device includes a filter head, with the filter head including an inlet port and an outlet port with each port configured to facilitate fluid movement into and out of the tank, respectively. A filter assembly is coupled to the filter head, with the filter assembly including a filter media extending along an axis into the interior of the tank. A wiper is operatively configured to engage a surface of the filter media. A motor is coupled to the filter head and the filter media, with the motor configured to move the filter media relative to the wiper, wherein solids filtered from the fluid by the filter media are dislodged from the filter media into the tank. The filter assembly is disposed in the tank between the inlet port and the outlet port.

In another embodiment, the liquid treatment system includes at least one additional self-cleaning filter device coupled to the top portion of the tank and exposed to the interior of the tank and parallel circuit with the other self-cleaning filter device. An outlet manifold, with a separate outlet conduit extending from each of the self-cleaning filter devices are joined at a common outlet port.

The liquid treatment system may include one additional tank defining an interior having a volume of at least 25 gallons with such additional tank including one or more self-cleaning filter devices coupled to the top portion of the additional tank with the two tanks coupled together as part of the system.

In yet another aspect, the disclosure provides a liquid treatment system including a tank that defines an interior having a volume of at least 25 gallons. The tank includes a gravity settling portion proximate a lower end of the tank. The tank also includes a connection port defined in a side of the tank, in fluid communication with the tank interior, through which fluid is introduced into the tank. A self-cleaning filter device is coupled to a top portion of the tank and configured to filter out solids from the fluid entering the tank and return filtered solids to the tank. Solids in the fluid entering the tank are removed from the fluid by the filter device and by gravity. The self-cleaning filter device includes a filter head, with the filter head including an outlet port configured to facilitate fluid movement out of the tank. A filter assembly is coupled to the filter head, with the filter assembly including a filter media extending along an axis into the interior of the tank. A wiper is operatively configured to engage a surface of the filter media. A motor is coupled to the filter head and the filter media, with the motor configured to move the filter media relative to the wiper, wherein solids filtered from the fluid by the filter media are dislodged from the filter media into the tank. The filter assembly is disposed in the tank between the connection port and the outlet port.

Other aspects, objectives and advantages of the liquid treatment system will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a liquid treatment system, including a tank with two self-cleaning filter devices;

FIG. 2 is a top plan view of the liquid treatment system illustrated in FIG. 1;

FIG. 3 is a perspective view of an exemplary embodiment of a tank for the liquid treatment system illustrated in FIG. 1, including two self-cleaning filter devices coupled to the tank with filter media extending into the interior of the tank;

FIG. 4 is a cross-section of the tank illustrated in FIG. 3 along the line 4-4.

FIG. 5 is an illustration of an exemplary embodiment of a self-cleaning filter device illustrated in FIG. 1.

While the liquid treatment system will be described in connection with certain preferred embodiments, there is no intent to limit it to those embodiments. On the contrary, the intent is to cover all alternatives, modifications and equivalents as included within the spirit and scope of the disclosure as defined by the appended claims.

### DETAILED DESCRIPTION OF EXEMPLARY EMBODIMENTS

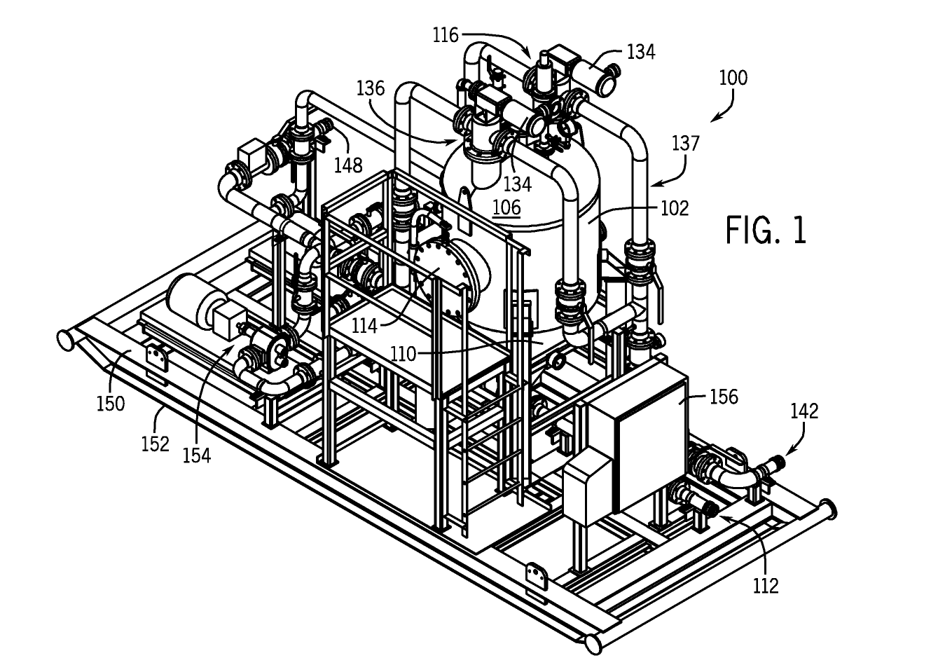

Referring now to the FIGS. 1-5, there is illustrated a liquid treatment system 100 that includes a tank 102 having at least one self-cleaning device 116 coupled to the tank. The liquid treatment system 100 does not required bag filters, bag drainage racks, use of filter consumables, and eliminates the need for an operator to manually change out bags from the tank.

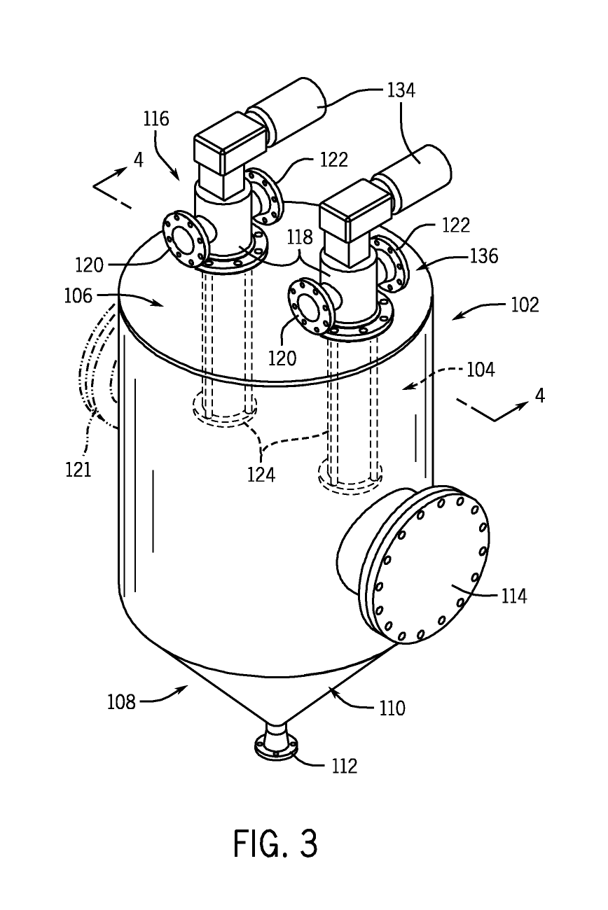

The tank 102 defines an interior 104 having a volume of at least 25 gallons. It should be understood that the system 100 also works with tanks defining at least 500 gallon in volume. It should be noted that the bag filter system in a conventional fluid treatment system is typically housed in a container or canister of between 1-6 gallon capacity. The larger tank volume, i.e. 25 gallon to 500 gallons facilitates the gravity settling function described below. The tank 102 of the present liquid treatment system 100 includes a gravity settling portion 110 approximate a lower end 108 of the tank. The tank further includes a top portion 106 which can be configured in a dome shape (see FIG. 1) or a flat shape (see FIG. 3) as determined by the manufacturer of the tank 102. The tank can be composed of any suitable material such as metal, for example steel, or an engineered plastic or any combination of such materials. The tank has to be composed of material that is suitable for its intended use, for example the oil and gas production industry.

The tank 102 includes a solids outlet 112 typically at the lower end 108 of the tank 102 for removal of solids that accumulate in the gravity settling portion 110 of the tank 102. The filtered and settled solids typically are inorganic solids held together in form of a sticky cake by organic compounds such as gels, heavy oil, grease, or other coagulants/flocculating agents. The solids filtered out of the liquid are periodically removed from the tank 102, for example by a vacuum truck coupled to the outlet 112. It is also contemplated that solids can be removed through an access port 114. The tank 102 defines the access port 114 which is configured to permit entry of one of a worker and a tool into the interior 104 of the tank 102. Such access port 114 facilitates periodic cleaning of the tank 102 as necessary.

The liquid treatment system 100 also includes a self-cleaning filter device 116 which is coupled to a top portion 106 of the tank 102. The self-cleaning filter device 116 is configured to filter out solids from fluid entering the tank 102 and return filtered solids to the tank. The solids in the fluid entering the tank 102 are removed from the fluid by the filter device 116 and by gravity.

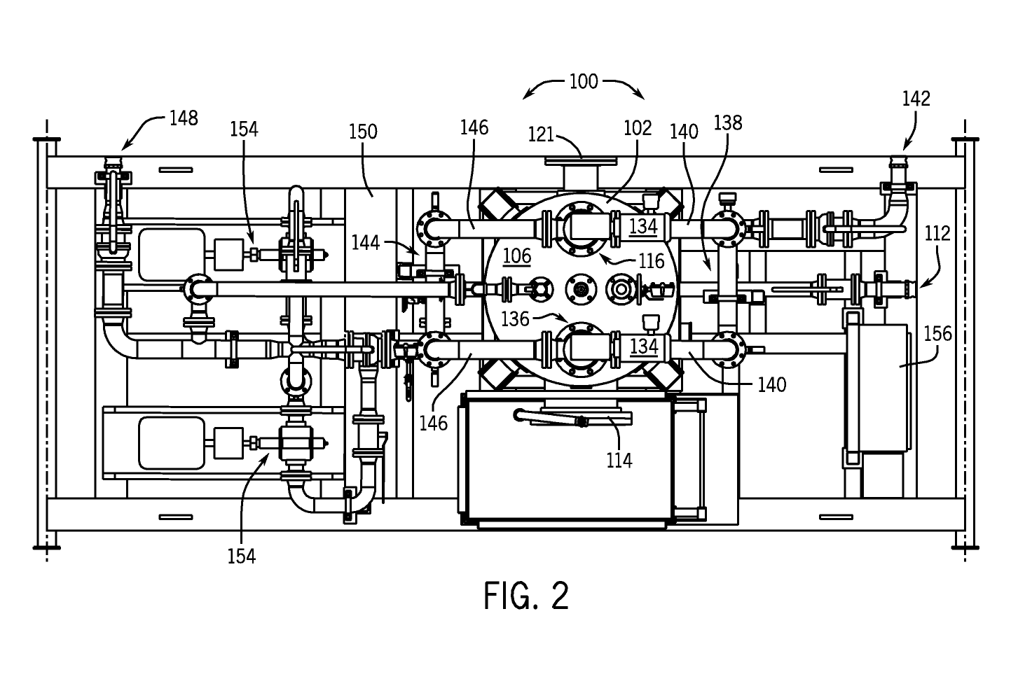

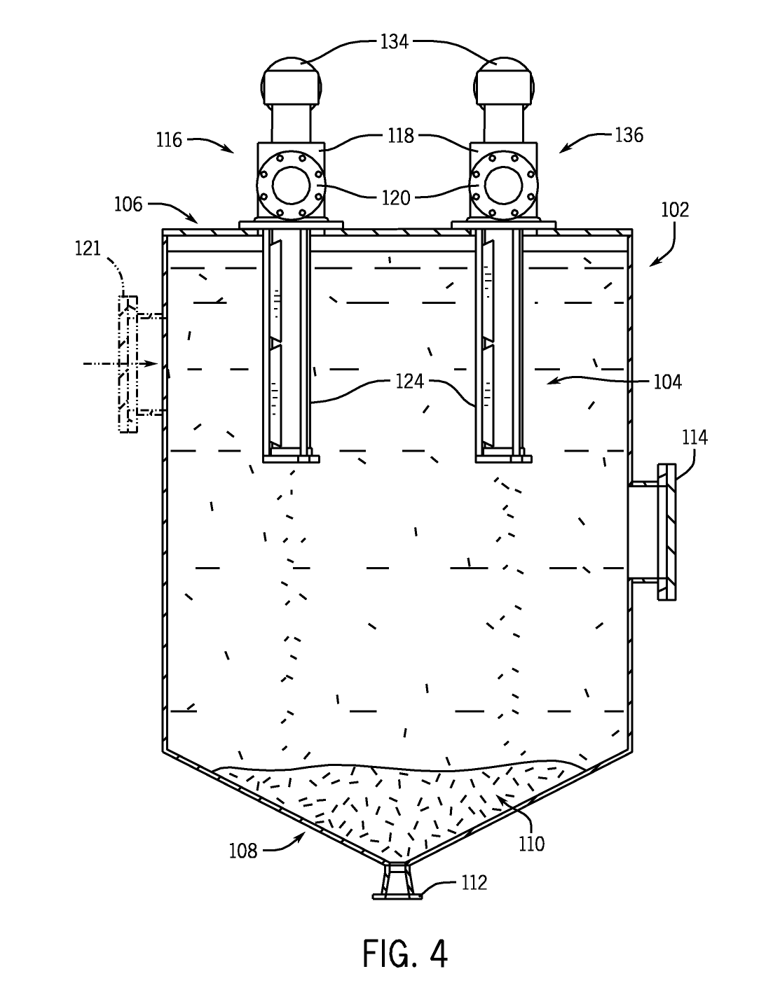

In a typical operation. fluid to be treated is transported to the liquid treatment system 100, normally by tanker trucks. The fluid can be waste water from fossil fuel drilling operations, general industrial processing, refinery and chemical processing facilities. The tanker truck will couple to the liquid treatment system 100. In the embodiment of the liquid treatment system illustrated in FIG. 2, the liquid to be filtered is coupled to the common system inlet port 148. The liquid is moved through the inlet conduit 146 to the filter head 118 through inlet port 120. After the liquid enters the inlet port it will be directed to the tank interior 104. Once the liquid enters interior 104, the liquid's flow velocity will decrease to a point where solids and semi-solids with enough mass will gravity settle to the gravity settling portion 110. (See FIG. 4) The gravity settling stage of the process will greatly reduce the contaminant load that the filter media 126 has to handle, resulting in lower energy use, and less wear on the filter assembly 124. The second stage of the process takes place once the liquid moves from the interior 104 to the filter media 126 of the filter assembly 124. The filter media 126 will screen out and remove particles of a certain size from the exiting liquid stream.

The self-cleaning filter device 116 includes a filter head 118, a filter assembly 124, and a motor 134. The filter head 118 includes an inlet port 120 and an outlet port 122 with each port configured to facilitate fluid movement into and out of the tank 102, respectively. In FIGS. 1 and 2, there are two self-cleaning filter devices 116, 136. In the following description, the self-cleaning filter devices are identical.

Coupled to the filter head 118 is a filter assembly 124. The filter assembly includes a filter media 126 extending along an axis 130 into the interior 104 of the tank 102. (See FIG. 4) A wiper 132 is operatively configured to engage a surface 128 of the filter media 126. A motor 134 is coupled to the filter head 118 and the filter media 126. The motor is configured to move the filter media 126 relative to the wiper 132 wherein solids filtered from the fluid by the filter media 126 are dislodged from the surface 128 of the filter media 126 and gravity drop into the tank 102. The filter assembly 124 is disposed in the tank 102 between the inlet port 120 and the outlet port 122 of the self-cleaning filter device 116.

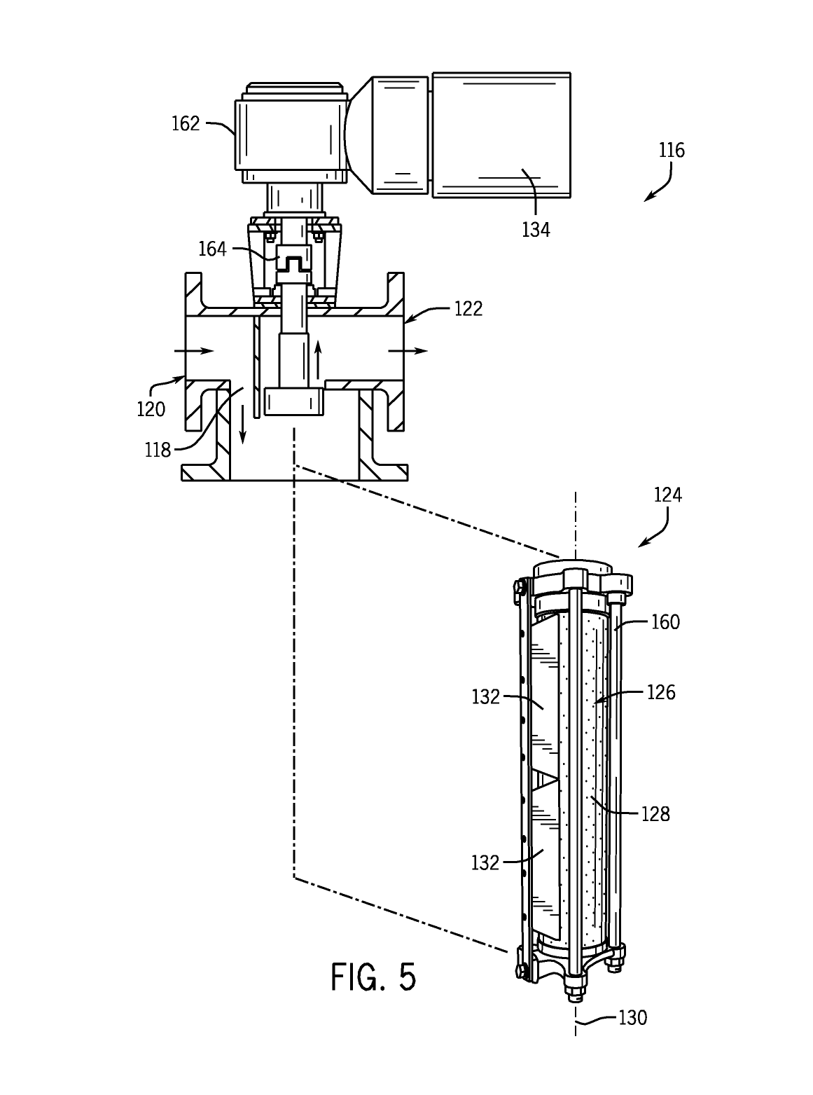

In an exemplary embodiment of the filter media 126, a fine wedge-shaped metal ribbon is wound helically on a perforated metal core. The space between each ribbon determines the micron rating of the filter, for example, 20 to 300 micron. The space is controlled by forming projections on the ribbon during the winding process. The tapered flow paths in the filter media 126 typically prevents clogging with solid particles that fail to pass through the flow paths are captured by the surface 128 of the filter media 126. The solids that do pass through the filter media 126 move into the tank interior 104 and settle into the gravity settling portion 110 of the tank 102. The solid particles that are trapped by the filter media 126 are periodically cleaned from the surface 128 of the filter media by movement of the filter media 126 wherein the particles are scrapped from the surface 128 by the wiper 132. The wiper 132 can be configured as a single member or as a plurality of portions aligned parallel to the filter media and coupled to the filter assembly 124 framework 160. (See FIG. 5). The wiper 132 extends the full length of the filter media 126 and may be adjustable relative to the filter media 126. With the present configuration, there is no need to stop the filtering process to change out filter cartridges as is typically required with the bag filter systems currently in operation.

In an additional embodiment, the inlet conduit or piping 146 can also be connected directly to tank 102 resulting in additional gravity settling of even smaller particles. Inlet port 120 of filter device 116 and 136 would be plugged off (blinded) and the piping redirected to a connection port 121 on the side of tank 102. Moving the connection port 121 to tank 102 and away from the filter assembly 124 would allow an increase in liquid flow residence time resulting in more solid and semi-solid contaminates being gravity settled. This alternative embodiment would be beneficial for liquid streams with extremely high contaminant content.

As illustrated in FIGS. 1 and 2, a parallel circuit 137 including a self-cleaning filter device 116 and an additional self-cleaning filter device 136 which are coupled to the top portion 106 of the tank 102 with each filter assembly 124 of the two self-cleaning filter devices extending into the interior 104 of the tank 102. The common system inlet port 148 is coupled to each of the self-cleaning filter devices through an inlet manifold 144 which includes inlet conduit 146. Likewise, each of the self-cleaning filter devices 116, 136 are coupled to the common system outlet port 142 by an outlet manifold 138 and associated outlet conduit 140. The piping (conduits) of the system 100 are sized and composed of material suitable for the intended application.

Each of the self-cleaning filter devices 116, 136 includes a motor 134 which is coupled to the filter media 126 through a gear box 162 and a coupling 164. (See FIG. 5). Control of each of the self-cleaning devices 116, including the motor 134 is affected by a controller 156. The controller 156 is coupled to each of the motors 134 as well as two pumps 154 associated with the liquid treatment system 100. The controller 156 will be utilized to control the rotation frequency and speed of the filter media 126. The rotation frequency and speed will be set differently, and be adjustable , for different contaminant loads, particle size distributions, and mixtures. The ability to adjust the filter media 126 rotation against the wiper 132 will allow for the optimization of energy use, filtration efficiency, and parts wear. The controller can also be coupled to sensors, for example flow meters, viscosity meters, weighing devices, etc. with the data passing through the controller to other devices as determined by the user of the liquid treatment system 100.

The liquid treatment system 100 is supported on a chassis 150 which is configured to receive and support the tank 102 and the associated equipment as illustrated in FIGS. 1 and 2. The chassis 150 may also be configured with ground support members 152 such as skids, wheels, tracks, or legs. The chassis 150 is configured for permanent installation at a liquid treatment plant and it can also be configured for portability and movement from one site to another site as determined by user.

A pump 154 is mounted on the chassis 150 with the pump 154 coupled to the self-cleaning device 116 through the inlet conduit 146 and configured to pump fluid into the tank 102. The pump 154 and associated motor is controlled by the controller 156 and moves the fluid from the common system inlet port 148 through the tank 102 and filtering system to the common system outlet port 142. A solid outlet 112 is coupled to the gravity settling portion 110 of the lower end 108 of the tank 102 for periodic removal of solids extracted from fluid passing through the tank 102. In some configurations, the pump 154 and the associated connection and conduits can be by-passed when a tanker truck has an on-board pump that will produce enough energy to move fluid through the system 100. In such case, wear and tear on the pump 154 is minimized. The tanker truck can couple to the common inlet port 148 or to the tank connection port 121 as determined by the user.

It should be understood that appropriate valving and couplings are utilized throughout the liquid treatment system 100 and configured from appropriate materials and sized appropriately for the specific application of the liquid treatment system 100.

As illustrated in FIGS. 1 and 2, the liquid treatment system 100 tank 102 includes two self-cleaning filter devices 116, 136. It should be understood that additional tanks 102 and associated self-cleaning filter devices can be coupled together in parallel or series and mounted on the chassis 150 as determined by the user. It should also be understood that separate liquid cleaning system 100 configurations as illustrated in FIGS. 1 and 2 can be coupled in parallel or in series on separate chassis 150.

The controller 156 may be a microprocessor coupled to the various apparatus of the system 100. The controller 156 may also be a server coupled to an array of peripherals or a desktop computer, or a laptop computer, or a smart-phone. It is also contemplated that the controller is configured to control each individual machine and may be remote from any of the apparatus. Communication between the controller 156 and the various apparatus, for example the filter motor 134, the pumps 153, or any sensor, may be either by hardwire or wireless devices. A memory/data base coupled to the controller may be remote from the controller 156. The controller 156 typically includes an input device, for example a mouse, or a keyboard, and a display device, for example a monitor screen or a smart phone. Such devices can be hardwired to the controller or connected wirelessly with appropriate software, firmware, and hardware. The display device may also include a printer coupled to the controller 156. The display device may be configured to mail or fax reports as determined by a user. The controller 156 may be coupled to a network, for example, a local area network or a wide area network, which can be one of a hardwire network and a wireless network, for example a Bluetooth network or internet network, for example, by a WIFI connection or “cloud” connection.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the disclosure.

Preferred embodiments of a liquid treatment system are described herein, including the best mode known to the inventors. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A liquid treatment system comprising:
a tank defining an interior having a volume of at least 25 gallons; with the tank including a gravity settling portion proximate a lower end of the tank and
a self-cleaning filter device coupled to a top portion of the tank; and configured to filter out solids from fluid entering the tank and return filtered solids to the tank, wherein solids in the fluid entering the tank are removed from the fluid by the filter device and by gravity.

2. The liquid treatment system of claim 1, wherein the self-cleaning filter device comprises:
a filter head, the filter head including an inlet port and an outlet port each configured to facilitate fluid movement into and out of the tank respectively;
a filter assembly coupled to the filter head, the filter assembly including a filter media extending along an axis into the interior of the tank and a wiper operatively configured to engage a surface to the filter media; and
a motor coupled to the filter head and the filter media, the motor configured to move the filter media relative to the wiper, wherein solids filtered from the fluid by the filter media are dislodged from the filter media into the tank, with the filter assembly disposed in the tank between the inlet port and outlet port.

3. The liquid treatment system of claim 1, further comprising at least one additional self-cleaning filter device coupled to the top portion of the tank and exposed to the interior of the tank in parallel circuit with the other self-cleaning filter device.

4. The liquid treatment system of claim 3, further comprising an outlet manifold with a separate outlet conduit extending from each self-cleaning filter device and joined at a common outlet port.

5. The liquid treatment system of claim 1, further comprising a chassis configured to receive and support the tank.

6. The liquid treatment system of claim 5, further comprising a pump mounted on the chassis with the pump coupled to the self-cleaning device with an inlet conduit and configured to pump liquid into the tank.

7. The liquid treatment system of claim 5, further comprising ground support members coupled to the chassis.

8. The liquid treatment system of claim 1, further comprising an access port defined in the tank, the access port configured to permit entry of one of a worker and a tool into the interior of the tank.

9. The liquid treatment system of claim 1 further comprising at least one additional tank defining an interior having a volume of at least 25 gallon and
a self-cleaning filter device coupled to a top portion of the additional tank and configured to filter out solids from fluid entering the tank and return filtered solids to the tank, wherein solids in the fluid entering the tank are removed from the fluid by the filter device and by gravity, wherein the one additional tank is coupled to the other tank.

10. The liquid treatment system of claim 9, wherein the one additional tank is coupled to the other tank in series.

11. The liquid treatment system of claim 1, wherein the tank defines an interior having a volume of at least 400 gallons.

12. The liquid treatment system of claim 1, wherein the fluid entering the liquid treatment system is waste water at a mining facility.

13. The liquid treatment system of claim 1, including a solids outlet defined in the lower end of the tank and configured to facilitate extraction of solids from the tank.

14. A method of treating fluid in a liquid treatment system, the liquid treatment system including a tank defining an interior having a volume of at least 25 gallons, with the tank including a gravity settling portion proximate a lower end of the tank and a self-cleaning filter device, the method comprising:
transporting liquid to the tank;
moving the liquid into the tank;
removing a portion of solids from the liquid by gravitational settling into the gravity settling portion;
moving the liquid through the self-cleaning filter device wherein an additional portion of solids in the liquid is removed by the filter; and
removing the liquid from the tank.

15. The method of treating fluid in a liquid treatment system of claim 14, wherein the moving of the liquid into the tank is done intermittently with sufficient time between movements to allow for settling of the solids removed from the liquid by both the filter and gravity settling.

16. The method of treating fluid in a liquid treatment system of claim 14, wherein the liquid is waste water obtained from a fossil fuel drilling operation.

17. The method of treating fluid in a liquid treatment system of claim 16, wherein the waste water is salt water.

18. The method of treating fluid in a liquid treatment system of claim 14, wherein a pump moves the liquid into the tank , through the filter, and out of the tank.

19. The method of treating fluid in a liquid treatment system of claim 14, further comprising removing solids filtered from the fluid by the self-cleaning filter into the gravity settling portion of the tank.

20. The method of treating fluid in a liquid treatment system of claim 19 further comprising removing any solids settled from the liquid in the gravity settling portion of the tank.

21. A liquid treatment system comprising:
a tank defining an interior having a volume of at least 25 gallons; with the tank including a gravity settling portion proximate a lower end of the tank and
a self-cleaning filter device coupled to a top portion of the tank and configured to filter out solids from fluid entering the tank and return filtered solids to the tank, wherein solids in the fluid entering the tank are removed from the fluid by the filter device and by gravity, wherein the self-cleaning filter device comprises:
a filter head, the filter head including an inlet port and an outlet port each configured to facilitate fluid movement into and out of the tank respectively;
a filter assembly coupled to the filter head, the filter assembly including a filter media extending along an axis into the interior of the tank and a wiper operatively configured to engage a surface to the filter media; and
a motor coupled to the filter head and the filter media, the motor configured to move the filter media relative to the wiper, wherein solids filtered from the fluid by the solids in the fluid entering the tank are removed from the fluid by the filter device and by gravity, wherein the self-cleaning filter device comprises:
a filter head, the filter head including an outlet port configured to facilitate fluid movement out of the tank;
a filter assembly coupled to the filter head, the filter assembly including a filter media extending along an axis into the interior of the tank and a wiper operatively configured to engage a surface to the filter media; and
a motor coupled to the filter head and the filter media, the motor configured to move the filter media relative to the wiper, wherein solids filtered from the fluid by the filter media are dislodged from the filter media into the tank, with the filter assembly disposed in the tank between the connection port and outlet port.

29. The liquid treatment system of claim 28, further comprising at least one additional self-cleaning filter device coupled to the top portion of the tank and exposed to the interior of the tank in parallel circuit with the other self-cleaning filter device, and an outlet manifold with a separate outlet conduit extending from each self-cleaning filter device and joined at a common outlet port.

30. The liquid treatment system of claim 28, further comprising an access port defined in the tank, the access port configured to permit entry of one of a worker and a tool into the interior of the tank.

31. The liquid treatment system of claim 28 further comprising at least one additional tank defining an interior having a volume of at least 25 gallon and
a self-cleaning filter device coupled to a top portion of the additional tank and configured to filter out solids from fluid entering the tank and return filtered solids to the tank, wherein solids in the fluid entering the tank are removed from the fluid by the filter device and by gravity, wherein the one additional tank is coupled to the other tank.

32. The liquid treatment system of claim 28, wherein the fluid entering the liquid treatment system is waste water at a fossil fuel facility.

33. The liquid treatment system of claim 28, including a solids outlet defined in the lower end of the tank and configured to facilitate extraction of solids from the tank.
